(19) United States
(12) Patent Application Publication
(10) Pub. No.: US 2011/0276639 A1
(43) Pub. Date: Nov. 10, 2011

(54) SOCIAL NETWORK ALERT SYSTEM

(76) Inventor: Whitney Henderson Schrader, Nashville, TN (US)

(21) Appl. No.: 12/941,900

(22) Filed: Nov. 8, 2010

Related U.S. Application Data
(60) Provisional application No. 61/258,881, filed on Nov. 6, 2009.

(51) Int. Cl. G06F 15/16; G06Q 30/00

(52) U.S. Cl. 709/206; 709/204; 705/14.73; 705/14.12

(57) ABSTRACT

A social network alert system for automatically identifying users with compatible interests has been developed. The system includes a subscriber with identified demographic information that is stored on a mobile electronic device. A server connects wirelessly with the subscriber and receives the demographic information and geographic location. The server then identifies other subscribers with compatible demographic information and sends an automatic notice of the location of the others to the first subscriber.

### CROSS-REFERENCE TO RELATED APPLICATIONS

This application claims priority from U.S. Provisional Patent Application No. 61/258,881 entitled “Social Network Alert System” that was filed on Nov. 6, 2009.

### FIELD OF THE INVENTION

The invention relates generally to computer software. More specifically, the present invention is a social network alert system based on self-identified common interests.

### SUMMARY OF THE INVENTION

In some aspects, the invention relates to a social network alert system, comprising: a first user with identified demographic information that is stored on an electronic readable media in a mobile electronic device; a server that connects wirelessly with the first user's mobile electronic device and receives the first user's demographic information and geographic location; where the server identifies a second user with demographic information that is compatible with the first user and where the second user is located within an identified geographic proximity of the first user; and where the server sends an automatic notice of the location to the second user to the first user's mobile electronic device.

In other aspects, the invention relates to a social network alert system, comprising: a first user with identified demographic information that is stored on an electronic readable media in a mobile electronic device; means for wirelessly connecting with the first user's mobile electronic device and receiving the first user's demographic information and geographic location; means for identifying a second user with demographic information that is compatible with the first user and where the second user is located within an identified geographic proximity of the first user; and means for sending an automatic notice of the location to the second user to the first user's mobile electronic device.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a view of a startup display showing how a user will define their search spotlight and surface time to introduce themselves to a mutual friend in one embodiment of the present invention.

FIG. 2 shows a view of a social network system alert for an introduction to a mutual friend via their common connection used in one embodiment of the present invention.

FIG. 3 shows a view of potential primary friends located within a search radius display from the alerts in FIG. 2 in one embodiment of the present invention.

FIGS. 4a and 4b show views of displays of conversations will be displayed in one embodiment of the present invention.

FIG. 5 shows a view of a user profile with demographic information so that they are introduced to nearby mutual friends with mutual demographic interests in one embodiment of the present invention.

FIGS. 6a and 6b show diagrams of the operation of the present invention in awarding social points in one embodiment of the present invention.

### DETAILED DESCRIPTION

The present invention is a social network system that introduces potential friends by geographic proximity and mutual contacts. The system is primarily used through smart phones and PDAs but can be used with other similar mobile devices such as laptop computers, GPS units, etc. Each subscriber will have a list of all their primary contact's contacts. This pool of secondary contacts will be each subscriber's “smart list”. People will post their smart list, their location and the duration of their location to a third party server. When two people with matching contacts in their smart lists update their location such that they are both within each other's search proximity, each will be sent a notification of their mutual contact to their mobile devices.

The system has several different application as follows:

Friends Application:

This application of the system also applies to two parties identifying one another based on proximity and mutual interests. One person can define their demographic information and post it to a profile in their proximity search, such that if two parties share a mutual contact, mutual demographic information and geographic location, their mobile devices will each be notified through a third party server.

Market Application:

This application of the system also applies to two parties identifying one another based on proximity and a mutual sales interest. One person can describe what they wish to sell and post it to a profile in their proximity search. When two parties sharing a mutual interest in selling or buying an item or service, and are in each other's search proximity, each will both be notified by their mobile devices through a third party server.

Business Application:

This application of the system also applies to two parties identifying each other based on proximity and a mutual business relationship. One person can identify their career skill sets, career field, GPA, etc. in a professional profile. When two people are within each other's proximity search they will be notified of potential business relationships based on mutual companies, skill sets, trade, education background etc. This search may be performed two ways: matching mutual contacts and then identifying their business profile, or matching mutual business profiles and then identifying any mutual contacts.

It should be noted that the descriptions and examples given in the Figures show applications of the present invention for use with Apple's® iPhone or iTouch devices. However, it should be understood that the system can be used with any interactive mobile device.

In some embodiments, the system will be started with an initial setup icon. Upon clicking on the icon, the application will open to a home screen with five buttons shown to the right. From left to right these icons will be called:
introduce yourself;
find friends (with a compass);
notify friends;
messages;
settings (with gears icon).

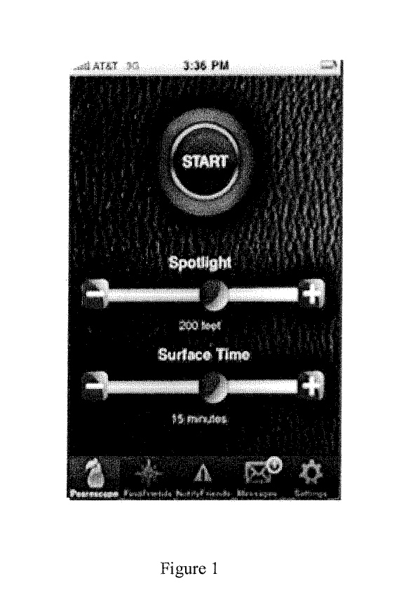

In the example shown in FIG. 1, the user will select the setup icon from the application's home screen and be brought to a screen with two settings bars that look like the “volume adjust” bar. The setup feature will allow the user to set their search radius and location duration. The sliding scale for the search radius will be called “Spotlight”. this spotlight will have a minimum radius of 20 feet, a max of 5 mile and a median of 500 feet. Below the Spotlight bar, will be a settings bar for the duration of a user's pin location. This duration setting will be called “Surface Time” with a minimum in this example of 5 minute and a max unlimited time and a median of 1 hr. The setup page will open up to the user's last settings.

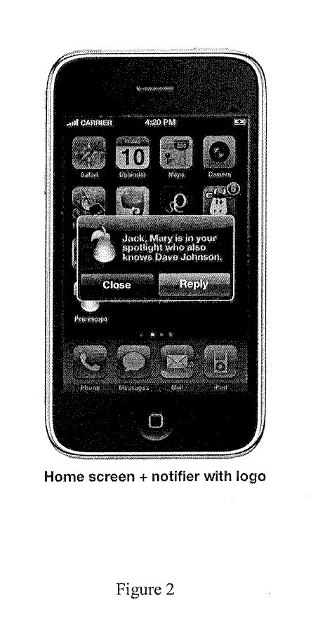

On this same page will be a startup button. When the user pushes this button, they will push their location and time to the server database. This will automatically begin the search for matches. When a match is made, a user will be notified much like they are via text message. An example of a notification is shown in FIG. 2. A message will then be sent to their PDA. The system icon will show the number of introductions that have occurred in color in the icon's bottom right corner as shown in FIG. 1. Users will have the option to reply directly from the PDA home screen much like text messaging.

Leveraging mutual connections for future meetings:

The present invention will have a unique “Future me” feature which will allow a user to post their future location, search spotlight, and duration in some embodiments. This will allow members to network in the future. Two members traveling to another city may login via their online account and drop their location in that city. The present invention will introduce future spotlights to both members via their PDAs and email so that they can set up meetings. The present invention will still apply the same secondary filters that match members by demographic interests. The “future me” service still applies the same search spotlight and surface time settings but applies it to future dates and locations. Those who are presently in that location may also elect to see future me icons on their Find Friends screen as well as be introduced to mutual friends that will be in that location in the future.

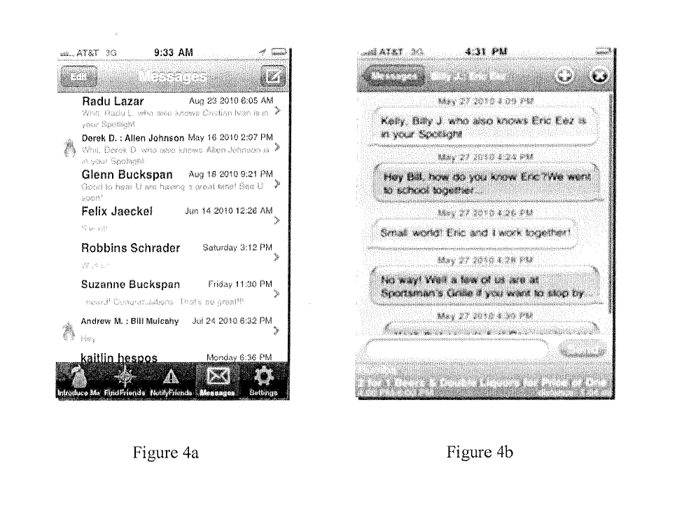

When opening the system application to read a message, the user will find the sum of new introduction notification(s), in the top right corner of the messages icon from the app's home page. These conversations will be binned much like text message conversations. Conversations will appear in the same layout as the PDA's native text messaging conversation layout. FIGS. 4a and 4b show views of displays of conversations will be displayed in one example of the present invention. Icons indicate a mutual connection has been made. Local advertisements may be displayed in the bottom of the conversation window. Members add mutual friends to their primary friends via a circle in the top right corner. They may also block future communication.

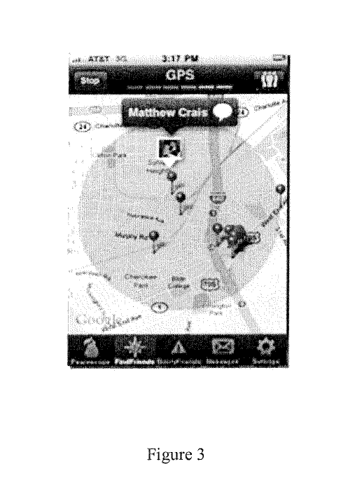

From the system home page, a user can select the compass icon to find their primary friends. Before finding their friends they will select their spotlight and surface time settings for their primary friends. Note that this is different from the initial settings of systems. The “find friends” page will open up to the users last spot light and surface time settings. When a user searches for their friends they will see a radius for their spotlight as shown in FIG. 3. If friends are located in their spotlight, they will show up as colored pins within the radius.

If a user wants to converse with one of his located friends, he may do so by selecting one of the icons to id who it is that is in their spotlight, and then selecting a message bubble icon go to a “chat” option window. This sends the user to a screen much like their text message window, however, the addressed user's name is already filled in. A user will also be able to select multiple pins and send a group message.

When a user receives a message from a friend it will look something like a standard text message. As with the system introductions, these “primary friend” notifications will be tallied on the home screen in the above right corner of the system icon with any other introductions or updates. When the user opens the application, these notifications will also be tallied in the top right corner of the “messages” page icon.

The messages window will have a list of messages from friends and introductions. Messages from friends will appear with the friend's name in bold. System introductions will read “E-troduction through (name of mutual friend)”. Group messages will list the first two people's names of the group with a “. . . ” added if there are more than two recipients. In all cases, the user will see a time stamp of the last conversation or notification update. Dots will appear next to new messages, new introductions, or any updated conversations just as is normally seen in the standard iPhone text messaging menu.

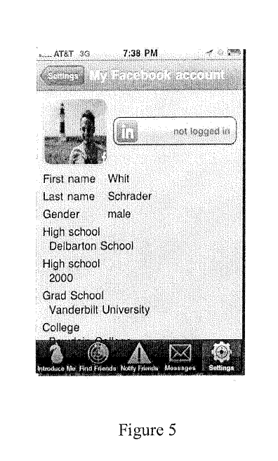

After downloading the application and opening it for the first time, the user will be asked what friends he wants to collect into his system service and will be able to do so by clicking on a Facebook® icon and a LinkedIN® icon. The user will sign in via one of their social networks to collect their primary contact info and then be asked if they want to invite their friends to this service. The user will have one button that invites all Facebook® friends to the system, one button that invites all LinkedIN® contacts, and an optional section to invite only certain people from each social network. FIG. 5 shows an example of a members demographic profile.

There will be privacy features that are included in the system. The system matches users to mutual friends and acquaintances only when and where they want. The user determines where they want to be seen and for how long. The user may: be invisible by nullifying a recent use; block certain friends from seeing them (to prevent spying, this would also prevent the user from seeing or being able to converse with those contacts); and unlink from Twitter® or Facebook® (which will be used to geolocate every time the user twitters or updates their Facebook status via their PDA). If the user is updating their geolocation using Twitter® or Facebook® the user would also have Facebook/Twitter® privacy settings: a default spotlight and surface time for their primary friends and a default spotlight and surface time for the system. This give the user peace of mind knowing they can have a conservative system and find friends setting that passively updates when they Twitter® or status update with Facebook®. The privacy settings page will also hold a “General Info” section that highlights the app's general features and also documents the system's legal information.

The system may also calculate a “smart list”. This is the list of each subscriber's contact's contacts. The smart list is calculated beforehand and updated once a day to reduce the amount of computation that the system web service must perform for each location, allowing the known service to scale to millions of users without any slowdown in performance.

This “smart list” will aggregate contacts across social networks. This will allow two people to meet each other across their social networks. If Person A knows B via Facebook® and B knows C via LinkedIN. A and C may still be introduced to one another via their mutual friend, B.

The system may also include advertising banners. The banners will have a discreet banner float on outside bottom edge of the conversation window. Every time a new conversation is updated a new banner will be posted underneath the conversation's window. If a user decides to click on the banner's x it will close banner. Upon clicking on an ad banner, a promotional bar codes may be also supplement the advertiser's message and offer promotions or discounts to the client based on their demographic information or present location.

Social gaming aspect:

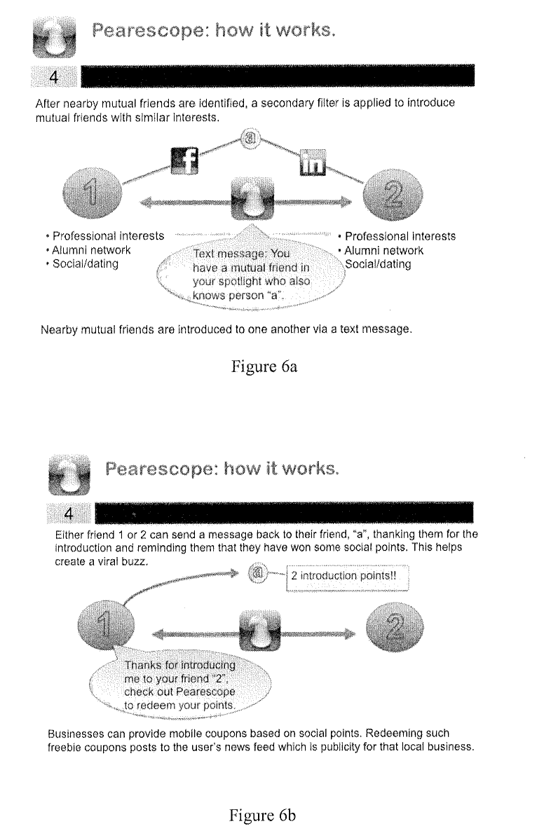

Unlike checking-in where members are rewarded for the frequency of checking in to a location, the present invention will offer a point system for those members who are most popular and introduce their friends to one another most often. If members A and B are introduced to one another via a mutual connection, C, that connection is awarded points. In this manner, those members who enable connections are rewarded for the breadth of their social networks. FIGS. 6a and 6b show diagrams that demonstrate how “social points” are awarded to members who enable new introductions. In this example, mutual friend, “A” is awarded points for introducing two friends 1 and 2 to each other.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A social network alert system, comprising:
a first user with identified demographic information that is stored on an electronic readable media in a mobile electronic device;
a server that connects wirelessly with the first user's mobile electronic device and receives the first user's demographic information and geographic location;
where the server identifies a second user with demographic information that is compatible with the first user and where the second user is located within an identified geographic proximity of the first user; and
where the server sends an automatic notice of the location to the second user to the first user's mobile electronic device.

2. The system of claim 1, where the identified demographic information of the first user comprises an electronic list of personal contacts.

3. The system of claim 2, where the compatible demographic information between the first user and the second user comprises common personal contacts.

4. The system of claim 3, where the common personal contacts between the first user and the second user are received by the server from multiple social network software applications.

5. The system of claim 1, where the compatible demographic information between the first user and the second user comprises items for sale.

6. The system of claim 1, where the compatible demographic information between the first user and the second user comprises mutual business interests.

7. The system of claim 1, where the first user can select what identified demographic information is received by the server.

8. The system of claim 1, where identified geographic proximity between the first user and the second user is selected by the first user.

9. The system of claim 1, where the first user selects a time duration for the server to identify a second user within the identified geographic proximity.

10. The system of claim 1, where the geographic location of the first user is pre-identified by the first user before the first user arrives at the geographic location.

11. The system of claim 1, further comprising:
where the server sends an automatic notice of the location to the first user to the second user.

12. The system of claim 1, where the automatic notice of the location of the second user to the first user comprises a text message.

13. The system of claim 1, where the server allows the first user and second user to communication with each other via text message.

14. The system of claim 1, where the demographic information of the first user is periodically updated automatically by the server.

15. The system of claim 1, where the geographic location of the first user is periodically updated automatically by the server.

16. The system of claim 1, where the interface with the first user will contain advertising.

17. The system of claim 1, where the automatic notice of the location of the second user will result in an award of points in an electronic game on the system.

18. A social network alert system, comprising:
a first user with identified demographic information that is stored on an electronic readable media in a mobile electronic device;
means for wirelessly connecting with the first user's mobile electronic device and receiving the first user's demographic information and geographic location;
means for identifying a second user with demographic information that is compatible with the first user and where the second user is located within an identified geographic proximity of the first user; and
means for sending an automatic notice of the location to the second user to the first user's mobile electronic device.
